(19) United States
(12) Patent Application Publication
(10) Pub. No.: US 2025/0330274 A1
(43) Pub. Date: Oct. 23, 2025

(54) SYSTEM, APPARATUS, AND METHOD OF JOINT CODING AND MIMO OPTIMIZATION

(71) Applicant: Huawei Technologies Co., Ltd., Shenzhen (CN)

(72) Inventors: Yu Cao, Kanata (CA); Huazi Zhang, Hangzhou (CN); Jianglei Ma, Ottawa (CA); Van Hung Vu, Gatineau (CA)

(21) Appl. No.: 19/258,595

(22) Filed: Jul. 2, 2025

Related U.S. Application Data
(63) Continuation of application No. PCT/CN2023/070020, filed on Jan. 3, 2023.

(51) Int. Cl. H04L 1/1812; H04B 7/0413

(52) U.S. Cl. CPC H04L 1/1812; H04B 7/0413

(57) ABSTRACT

A framework, corresponding methods, network devices, and apparatus for joint coding and MIMO optimization are provided that includes one or more of: a) MIMO layer mapping is performed per set of CB (SCB) rather than at the transport block (TB) level. An SCB may include one or more CB. In some cases, all SCBs include only one CB. b) Each SCB can have independent link adaptation (e.g. MCS and CB size) without a separate HARQ process and/or HARQ feedback per SCB; thus, the granularity of the HARQ process and/or HARQ feedback is at the TB level. c) Cross-CB coding may be applied over multiple SCBs, with the outputs of cross-CB coding mapped to separate MIMO layers to maximize performance, but without the use of per layer feedback or multiple TBs or HARQ processes; thus, the granularity of the HARQ process and HARQ feedback is at the TB level.

### CROSS-REFERENCE TO RELATED APPLICATION

This application is a continuation of International Application No. PCT/CN2023/070020, entitled “SYSTEM, APPARATUS, AND METHOD OF JOINT CODING AND MIMO OPTIMIZATION” and filed on Jan. 3, 2023, the disclosure of which is hereby incorporated by reference in its entirety.

### TECHNICAL FIELD

The application relates generally to wireless communications, and more specifically to methods of transmitting and receiving transmissions with multiple layers, such as a transmission that makes use of MIMO (multiple input multiple output).

### BACKGROUND

In the existing New Radio (NR) multiple MIMO layer scheme, up to two codewords (CW) mapped to up to 8 MIMO layers can be scheduled in one transmission. Each codeword carries a single transport block and has a separate modulation and coding scheme (MCS), hybrid automatic repeat request (HARQ) process identifier (ID), and HARQ feedback. A CW is a concatenation of multiple code blocks (CBs) of a transport block (TB) and the forward error correction (FEC) process within a CW is independent from MIMO layer mapping. In the existing NR multiple MIMO layer scheme, the transmission is first mapped to MIMO layers. Then, the transmission is mapped to frequency resources, followed by mapping to time resources.

### SUMMARY

A framework, corresponding methods, network devices, and apparatus for joint coding and MIMO optimization are provided that includes one or more of the following features: a) MIMO layer mapping is performed per set of CB (SCB) rather than at the transport block (TB) level. An SCB may include one or more CB. In some cases, all SCBs include only one CB. b) Each SCB can have independent link adaptation (e.g. MCS and CB size) without a separate HARQ process and/or HARQ feedback per SCB; thus, the granularity of the HARQ process and/or HARQ feedback is at the TB level. c) Cross-CB coding may be applied over multiple SCBs, with the outputs of cross-CB coding mapped to separate MIMO layers to maximize performance, but without the use of per layer feedback or multiple TBs or HARQ processes; thus, the granularity of the HARQ process and HARQ feedback is at the TB level.

According to one aspect of the present disclosure, there is provided a method comprising: transmitting a transmission of at least one transport block (TB), the TB comprising a plurality of sets of code blocks (SCBs), each SCB containing one or more code blocks (CBs), wherein each SCB is encoded and modulated to produce a corresponding set of modulated symbols, the transmission generated from a plurality of MIMO layers, wherein for each MIMO layer of the plurality of MIMO layers or for each group of MIMO layers of the plurality of MIMO layers, a respective one of said corresponding sets of modulated symbols is mapped to the MIMO layer or the group of MIMO layers; and receiving hybrid automatic repeat request (HARQ) feedback on a per TB basis.

In some embodiments, receiving HARQ feedback on a per TB basis comprises receiving a HARQ acknowledgment (ACK) or negative acknowledgment (NACK) for each TB without receiving HARQ feedback for the each SCB.

Advantageously, this provides increased flexibility in mapping to MIMO layers, which may have differing performances. This approach may be particularly useful for massive MIMO applications with a large number of layers.

In some embodiments, the respective set of modulated symbols is further mapped to resources in time and to resources in frequency after being mapped to the MIMO layer or the group of MIMO layers, using a configured order of mapping as between mapping to resources in time and mapping to resources in frequency.

Advantageously, this approach provides more flexible time-frequency-space mapping of code blocks for different application scenarios.

In some embodiments, the method further comprises: performing independent modulation and coding scheme (MCS) adaptation for each SCB.

Advantageously, this approach may improve spectrum efficiency and coding performance by allowing independent link adaptation for each code block. This may reduce signaling overhead and system complexity of managing multiple HARQ process for MIMO, by not relying on a respective HARQ process for each code block.

In some embodiments, for each SCB, performing independent MCS adaptation is based on the channel quality of the MIMO layer or the group of MIMO layers to which the SCB is mapped.

In some embodiments, for each SCB, a size of the SCB is based on resources available on the MIMO layer or the group of MIMO layers to which the SCB is mapped.

In some embodiments, wherein the transmission of the at least one TB further comprises a transmission of at least one cross-CB check block (CCB), each CCB being a check block based on a respective set of bits that includes at least one bit from each of the plurality of CBs of the TB.

In some embodiments, each CCB or each of at least one set of CCB is encoded, modulated, and mapped to a respective MIMO layer or group of MIMO layers of said plurality of MIMO layers.

In some embodiments, the method comprises: in respect of at least one of the at least one TBs, transmitting a retransmission of the TB, the retransmission comprising at least one cross-block check block (CCB), each CCB being a check block based on a respective set of bits that includes at least one bit from each of the plurality of CBs of the TB.

Advantageously, cross-CB coding can be used to apply to multiple CBs across MIMO layers without signaling overhead of multiple CWs and multiple HARQ processes and corresponding HARQ feedback. This approach can be used to achieve diversity gain without compromising CB level link adaptation. Each CB can be separately decodable to reduce decoding delay.

In some embodiments, the method further comprises transmitting or receiving signaling comprising or indicating one or more of the following: a number of TBs; for each TB, a corresponding HARQ process ID; number of MIMO layers that each SCB maps to; a respective MCS for each SCB; a maximum SCB size; a mapping method from SCBs to MIMO layers, frequency resources and time resources.

In some embodiments, the signaling comprising or indicating a mapping method from SCB(s) to MIMO layers, frequency resources and time resources indicates a particular mapping method from among a predetermined set of mapping methods that include at least two of the following methods: map to MIMO layer first, then to frequency resources, then to time resources; map to MIMO layer first, then to time resources, then to frequency resources.

In some embodiments, the method further comprises transmitting or receiving signaling content comprising or indicating one or more of the following: a number of TBs; for each TB, a corresponding HARQ ID; a number of MIMO layers that each SCB maps to and that each CCB maps to; a respective MCS for each SCB and for each CCB; a redundancy version; a number of CCBs included; a mapping method from SCB and CCBs to MIMO layers, frequency resources and time resources.

In some embodiments, the signaling comprising or indicating a mapping method from SCB and CCBs to MIMO layers, frequency resources and time resources indicates a particular mapping method from among a predetermined set of mapping methods that include at least two of the following methods: map to MIMO layer first, then to frequency resources, then to time resources; map to MIMO layer first, then to time resources, then to frequency resources.

In some embodiments, the method further comprises generating the transmission by, for each TB, segmenting the TB into the plurality of SCBs each comprising one or more code blocks (CB). The method further comprises generating the transmission by, for each SCB: encoding bits of the SCB to produce a number of coded bits; modulating the number of coded bits to produce the corresponding set of modulated symbols; and mapping the corresponding set of modulated symbols to the respective MIMO layer or group of MIMO layers to produce MIMO layer-mapped modulated symbols. The method further comprises generating the transmission by precoding the MIMO layer-mapped modulated symbols corresponding to the plurality of SCBs to produce antenna streams of the transmission.

In some embodiments, a size of SCB is based on the MIMO layer or group of MIMO layers that modulated symbols for that SCB are mapped to.

In some embodiments, performing encoding and modulation for each SCB comprises using a respective MCS that is specific to the SCB.

In some embodiments, the method is for execution by a base station, and wherein transmitting the transmission comprises transmitting the transmission by the base station over multiple antennas, and wherein receiving the HARQ feedback comprises receiving HARQ feedback by the base station.

In some embodiments, the method is for execution by an apparatus, and wherein transmitting the transmission comprises transmitting the transmission by the apparatus, and wherein receiving the HARQ feedback comprises receiving HARQ feedback by the apparatus.

According to another aspect of the present disclosure, there is provided a method comprising: receiving a transmission of at least one transport block (TB), the TB comprising a plurality of sets of code blocks (SCBs), each SCB containing one or more code blocks (CBs), wherein each SCB is encoded and modulated to produce a corresponding set of modulated symbols, the transmission generated from a plurality of MIMO layers, wherein for each MIMO layer of the plurality of MIMO layers or for each group of MIMO layers of the plurality of MIMO layers, a respective one of said corresponding sets of modulated symbols is mapped to the MIMO layer or the group of MIMO layers; and transmitting hybrid automatic repeat request (HARQ) feedback on a per TB basis.

In some embodiments, transmitting HARQ feedback on a per TB basis comprises transmitting a HARQ acknowledgment (ACK) or negative acknowledgment (NACK) for each TB without transmitting HARQ feedback for the each SCB.

In some embodiments, the respective set of modulated symbols is further mapped to resources in time and to resources in frequency after being mapped to the MIMO layer or the group of MIMO layers, using a configured order of mapping as between mapping to resources in time and mapping to resources in frequency.

In some embodiments, for each SCB, a size of the SCB is based on resources available on the MIMO layer or the group of MIMO layers to which the SCB is mapped.

In some embodiments, the transmission of the at least one TB further comprises a transmission of at least one cross-CB check block (CCB), each CCB being a check block based on a respective set of bits that includes at least one bit from each of the plurality of CBs of the TB.

In some embodiments, each CCB or each of at least one set of CCB is encoded, modulated, and mapped to a respective MIMO layer or group of MIMO layers of said plurality of MIMO layers.

In some embodiments, the method further comprises: in respect of at least one of the at least one TBs, receiving a retransmission of the TB, the retransmission comprising at least one cross-block check block (CCB), each CCB being a check block based on a respective set of bits that includes at least one bit from each of the plurality of CBs of the TB.

In some embodiments, the method further comprises transmitting or receiving signaling comprising or indicating one or more of the following: a number of TBs; for each TB, a corresponding HARQ process ID; number of MIMO layers that each SCB maps to; a respective MCS for each SCB; a maximum SCB size; a mapping method from SCBs to MIMO layers, frequency resources and time resources.

In some embodiments, the signaling comprising or indicating a mapping method from SCB(s) to MIMO layers, frequency resources and time resources indicates a particular mapping method from among a predetermined set of mapping methods that include at least two of the following methods: map to MIMO layer first, then to frequency resources, then to time resources; map to MIMO layer first, then to time resources, then to frequency resources.

In some embodiments, the method further comprises transmitting or receiving signaling content comprising or indicating one or more of the following: a number of TBs; for each TB, a corresponding HARQ ID; a number of MIMO layers that each SCB maps to and that each CCB maps to; a respective MCS for each SCB and for each CCB; a redundancy version; a number of CCBs included; a mapping method from SCB and CCBs to MIMO layers, frequency resources and time resources.

In some embodiments, the signaling comprising or indicating a mapping method from SCB and CCBs to MIMO layers, frequency resources and time resources indicates a particular mapping method from among a predetermined set of mapping methods that include at least two of the following methods: map to MIMO layer first, then to frequency resources, then to time resources; map to MIMO layer first, then to time resources, then to frequency resources.

In some embodiments, the method is for execution by a base station, and wherein receiving the transmission comprises receiving the transmission by the base station over multiple antennas, and wherein transmitting the HARQ feedback comprises receiving HARQ feedback by the base station.

In some embodiments, the method is for execution by an apparatus, and wherein receiving the transmission comprises receiving the transmission by the apparatus, and wherein transmitting the HARQ feedback comprises transmitting HARQ feedback by the apparatus.

According to another aspect of the present disclosure, there is provided a network device comprising a processor and memory, wherein the network device is configured to perform the method as described herein.

According to another aspect of the present disclosure, there is provided an apparatus comprising a processor and memory, wherein the apparatus is configured to perform the method as described herein.

According to another aspect of the present disclosure, there is provided a computer program product comprising instructions to cause a computer to perform the method as described herein.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIGS. 5A, 6, 7 and 8 are block diagrams of coding and MIMO structures provided by embodiments of the application;

FIGS. 5B and 5C are flowcharts of methods provided by embodiments of the application;

FIG. 9 is a flowchart of a method of coding and MIMO optimization provided by an embodiment of the application.

FIGS. 10 and 11 are block diagrams of coding and MIMO structures featuring cross code-block check blocks provided by embodiments of the application.

FIG. 12A shows an example of cross code-block encoding;

FIGS. 12B and 12C are examples of the use of different input bits for CCB generation.

### DETAILED DESCRIPTION

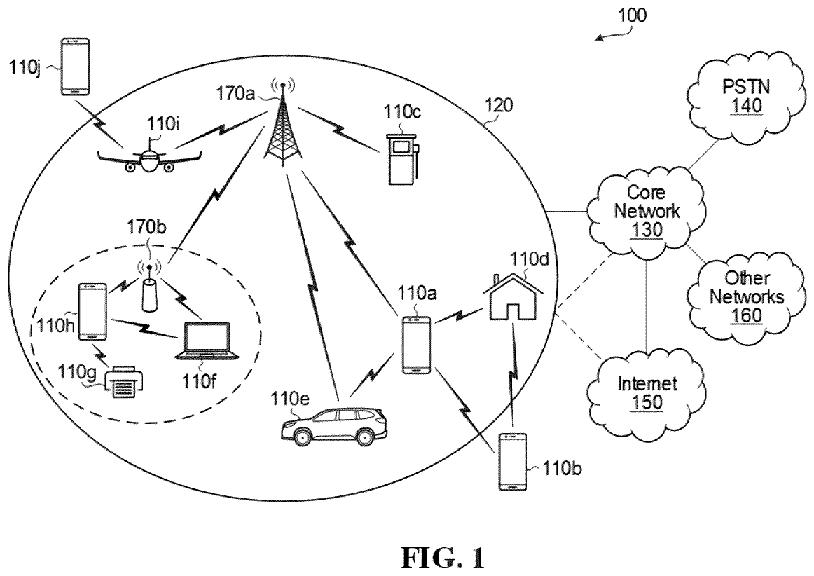

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

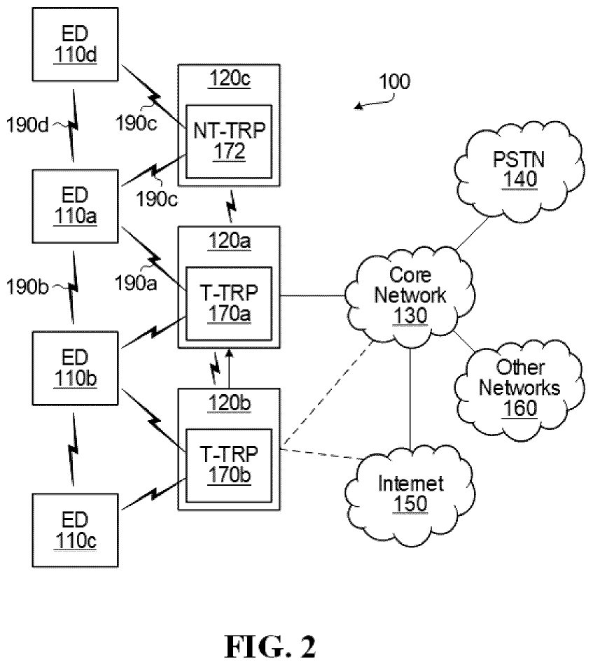

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

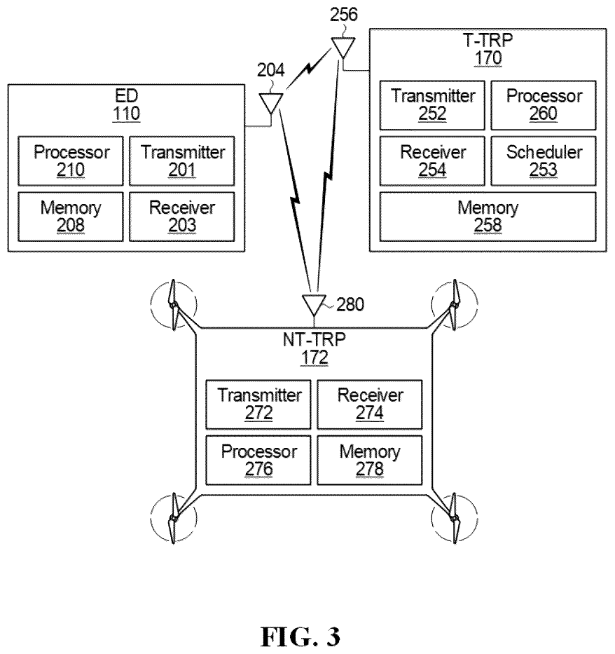

FIG. 3 illustrates another example of an ED 110 and a base station 170a and/or 170b. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a terrestrial node, a terrestrial network device, or a terrestrial base station, base band unit (BBU), remote radio unit (RRU), active antenna unit (AAU), remote radio head (RRH), central unit (CU), distributed unit (DU), or positioning node, among other possibilities. The T-TRP 170 may be macro BSs, pico BSs, relay node, donor node, or the like, or combinations thereof. The T-TRP 170 may refer to the forgoing devices or to apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

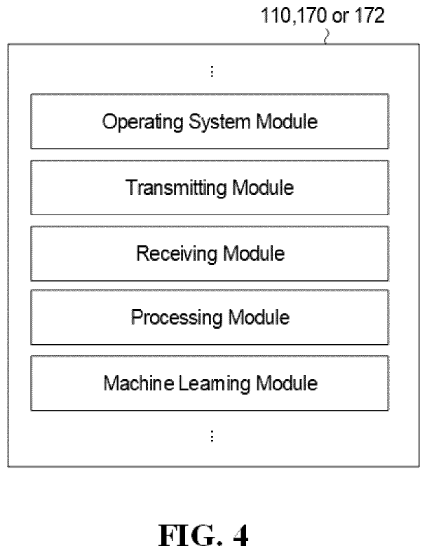

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those skilled in the art. As such, these details are omitted here.

Multiple-input multiple-output (MIMO) technology allows an antenna array of multiple antennas to perform signal transmissions and receptions to meet high transmission rate requirement. The above ED110 and T-TRP 170, and/or NT-TRP use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves for dozens of the ED 110 (such as 40) in the meanwhile. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and an ED 110 is obviously reduced, and the power efficiency is greatly increased. When the antenna number of the T-TRP 170, and/or NT-TRP 172 is sufficiently large, random channels between each ED 110 and the T-TRP 170, and/or NT-TRP 172 can approach to be orthogonal, and the interference between the cell and the users and the effect of noises can be eliminated. The plurality of advantages described above enable the large-scale MIMO to have a magnificent application prospect.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:

Panel: unit of antenna group, or antenna array, or antenna sub-array which can control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier

When a spatial multiplexing scheme is used, transmissions may be over multiple transmission layers. A transmission layer refers to a datastream that is transmitted. In the case of MIMO transmissions, there are at least two transmission layers, or more generally L transmission layers (where Lis at least two). The L transmission layers are mapped to N antenna streams (which are fed to respective transmission antennas (or antenna ports)) by means of a MIMO precoder matrix of size N×L. Generally, the number of transmission layers (i.e., L, also referred to as the transmission rank or, simply, the rank) is less than or equal to the number of antenna streams (i.e., N). In the present disclosure, there are at least two transmission layers for MIMO transmission, and the transmission layers may be referred to as MIMO layers.

In a solution for implementing MIMO in NR, an FEC CB segmentation and concatenation procedure is independent of a MIMO layer mapping procedure. Furthermore, link adaptation takes place at the TB level, with a single MCS for all the CBs in a TB that correspond to a HARQ process. In this conventional solution, a CW contains all the CBs of a TB, and MIMO layer mapping at the TB level is equivalent to mapping at the CW level. A maximum of two CWs per transmission is supported, with each CW mapped to up to 4 MIMO layers. Because there is no control of how each CB within a CW is mapped or optimized based on MIMO layers, each CB has to share the same MCS.

In a MIMO implementation with a large number of layers, the channel quality of each MIMO layer can vary significantly. NR's support for only a maximum of two TBs per transmission will limit spectral efficiency because link adaptation is not tailored to the channel quality of each MIMO layer. When one TB is mapped to multiple MIMO layers with varying channel quality, the decoding performance is not robust when combining layers with significantly varying channel quality. On the other hand, a one TB to one MIMO layer mapping scheme can result in efficient link adaptation, but will also result in high HARQ complexity and signaling overhead. That is why the current NR system is limited to a maximum of two TBs for each MIMO transmission. However, with future applications where the data payload can be much larger, and where much higher spectrum efficiency is required together with a need to support a massive number of layers, the maximum two TBs per MIMO transmission may not be sufficient.

In addition, though there may be many CBs in a TB, these CBs cannot be individually optimized in the conventional NR implementation described above. CB size is not related to its corresponding MIMO layer because there is no direct correspondence between CB and MIMO layer. Consequently, there is no control of a potential delay caused by a large CB, which might be problematic for low latency applications such as ultra reliable low latency communications (URLLC).

In the present disclosure, a framework for joint coding and MIMO optimization is provided that includes one or more of the following features, each of which is described in greater detail in the paragraphs below:
1. MIMO layer mapping is performed per set of CB (SCB) rather than at the transport block (TB) level. An SCB may include one or more CB. In some cases, all SCBs include only one CB.
2. Each SCB can have independent link adaptation (e.g. MCS and CB size) without a separate HARQ process and/or HARQ feedback per SCB; thus, the granularity of the HARQ process and/or HARQ feedback remains at the TB level, which helps avoid increasing HARQ-related overhead.
3. Cross-CB coding (described in detail below) may be applied over multiple SCBs, with the outputs of cross-CB coding mapped to separate MIMO layers to maximize performance, but without the use of per layer feedback or multiple TBs or HARQ processes; thus, the granularity of the HARQ process and HARQ feedback is at the TB level.

### MIMO Layer Mapping Per Set of CB

In the provided systems and methods, SCBs are mapped to MIMO layers by a layer mapping operation. The layer mapping operation may map a SCB to one or more MIMO layers based on predefined mapping rules (e.g., as defined in a standard), such as 1-to-1 mapping (i.e., one SCB mapped to one MIMO layer) or 1-to-many mapping (i.e., one SCB mapped to multiple MIMO layers). Different SCBs may be mapped to different numbers of MIMO layers (such that the M SCBs map to L MIMO layers, where L is greater than M). For example, if a TB has K SCBs each containing one CB (i.e. K CBs) that are to be mapped to K MIMO layers, a first CB (denoted CB1) may be mapped to MIMO layer 1, a second CB (denoted CB2) may be mapped to MIMO layer 2, and so forth until the K-th CB (denoted CBK) may be mapped to MIMO layer K. In another example, if a TB has 2 SCBs each containing one CB that are to be mapped to 4 MIMO layers, then CB1 may be mapped to MIMO layers 1 and 2, while CB2 may be mapped to layers 3 and 4. In yet another example, if a TB has 4 CBs that are to be mapped to 2 MIMO layers, then CB1 and CB2 (a first SCB of size 2) may be mapped to MIMO layer 1, and third and fourth CBs (denoted CB3 and CB4, respectively, forming a second SCB of size 2) may be mapped to MIMO layer 2. The preceding mapping rules are only some examples of possible predefined mapping rules. Other predefined mapping rules are possible and would be apparent to a person skilled in the art.

In another scenario, an SCB having multiple CBs may be mapped to multiple MIMO layers in a way such that the bits of all CBs in an SCB are interleaved together before mapping to the MIMO layers, such that each CB is spread over all MIMO layers to which the SCB is mapped. For example, if the SCB contains 4 CBs that are to be mapped to 4 MIMO layers, the first MIMO layer may include a first bit of CB1, a first bit of CB2, a first bit of CB3, and a first bit of CB4, followed by a second bit of CB1, a second bit of CB2, a second bit of CB3, a second bit of CB4, and so forth. In this way, each MIMO layer may contain a quarter of the bits from each of CB1, CB2, CB3, and CB4. It should be understood that the above SCB to MIMO layer mapping schemes may also be applicable to mapping of cross-block check blocks to MIMO layers. In general, it should be understood that there are various ways in which CBs (and cross-block check blocks, where applicable) may be mapped to MIMO layers, which are all within the scope of the present disclosure and which may be used in various examples described herein.

Each layer is a datastream, and the layers are processed by a MIMO precoder. The MIMO precoder maps the L MIMO layers to N antenna streams (where N is not necessarily equal to L), where each antenna stream may be further processed through time-frequency resource mapping as well as physical antenna mapping and is fed to a respective transmission antenna (or antenna port) for MIMO transmission.

In order to map a MIMO layer per SCB, a MIMO layer mapping rule is defined and applied for each SCB of a plurality SCBs of a TB, where each SCB has one or more CB. In some embodiments, all SCBs have only one CB. In other embodiments, at least one SCB of the plurality of SCBs has more than one CB. In other embodiments, all SCBs have more than one CB. In two examples of a MIMO layer mapping rule:
i. one SCB may be mapped to each MIMO layer;
ii. each SCB may be mapped to one MIMO layer, or to multiple consecutive MIMO layers.

In some embodiments, a flexible mapping scheme is provided. The mapping may be flexible in terms of the order of mapping CBs to MIMO layers, frequency resources, and time resources. For example, the mapping may map one SCB to all of a set of MIMO layers first, followed by mapping to frequency resources, and then mapping to time resources. This approach may be suitable in applications that would benefit from fast decoding and space-frequency diversity gain, such as ultra reliable low latency communications (URLLC) for example. In another example, the mapping may map one SCB to MIMO layers first, followed by mapping to time resources, followed by mapping to frequency resources. This approach may be suitable in applications that would benefit from time diversity, such as in a high movement speed application. More generally, in some embodiments, the order of mapping as between MIMO layer, frequency resource, and time resource, is configurable.

In a further example of flexible mapping, the starting point is a number of modulated symbols produced from an SCB (one or more CBs) that is to be mapped to L (>=1) layers. There are M (M>=1) time resource units (e.g., time symbols) in the time domain, and N (N>=1) frequency resource units (e.g., resource elements) per time symbol in the frequency domain available for the transmission. In this case, the total number of modulated symbols that can be transmitted is LxMxN. When mapping to resources, the first L modulated symbols are mapped to the L layers in the first time symbol t_1, and the first resource element f_1 of each time symbol. Then, if the mapping order is frequency first-time second, the next L modulated symbols will be mapped to the L layers in the first time symbol t_1, and the second resource element in frequency domain f_2. Continuing this mapping order, the next L modulated symbols will be mapped to the L layers in the first time symbol t_1, and the third resource element in frequency domain f_3, etc., until all the frequency domain resource elements of first time symbol are filled. The frequency first-time second mapping order then moves on to the next time symbol t_2, and so on until all resources are mapped. On the other hand, if the mapping order is time first-frequency second, after the first L modulated symbols are mapped to the L layers in the first time symbol t_1, and the first resource element in frequency domain f_1 of each time symbol, the next L modulated symbols will be mapped to L layers in the second time symbol t_2, and to the first resource element in frequency domain f_1, etc., until all time symbols of the first resource element in frequency domain f_1 has been filled. The time first-frequency second mapping order then moves on to the next resource element in frequency domain f_2, and so on.

### Link Adaptation at the SCB Level

By providing individual link adaptation at the SCB level, the MCS and the total size of an SCB is based on the MIMO layers to which the given SCB is mapped. Accordingly, decoding performance of the transmission may be improved because of the more accurate link adaptation to channel quality. Since multiple SCBs form a TB, and the TB remains the minimum unit for scheduling and HARQ process, the more accurate link adaptation may not unduly increase HARQ-related overhead. Moreover, the more accurate link adaptation allows for more accurate configuration of SCB size, which may improve latency.

### Cross-CB Coding

For a given TB, one or more additional CBs, referred to herein as cross-block check blocks (CCBs) may be transmitted. In embodiments of cross-CB coding:
i) One or more CCBs are determined. Each CCB is a block of coded bits that is generated based on a respective subset of bits from each of the SCBs of a TB. The SCBs to be transmitted include the original SCBs associated with a TB, and one or more sets of CCBs, each comprising one or more CCBs. The one or more set of CCBs can be transmitted in a separate retransmission or can be transmitted as part of the initial transmission.
ii) Each SCB to be transmitted (i.e., each original SCB and each set of CCBs) is mapped to a separate set of one or more MIMO layers (there is a diversity gain when more than one MIMO layer is used). Sets of CCBs are treated as SCBs in the mapping scheme. The MCS and the number of bits of a given set of CCBs can be determined based on the resources of the one or more MIMO layers to which the set of CCBs is mapped.
iii) Each SCB can have independent MCS adaptation and SCB size.
iv) At the receiver, HARQ feedback is performed at the TB level. The SCBs that were input to the cross-CB coding scheme are jointly decoded at the receiver. All SCBs involved in the joint decoding of the cross-CB coding scheme belong to a single TB, and as such, there is no need for per-layer HARQ feedback.

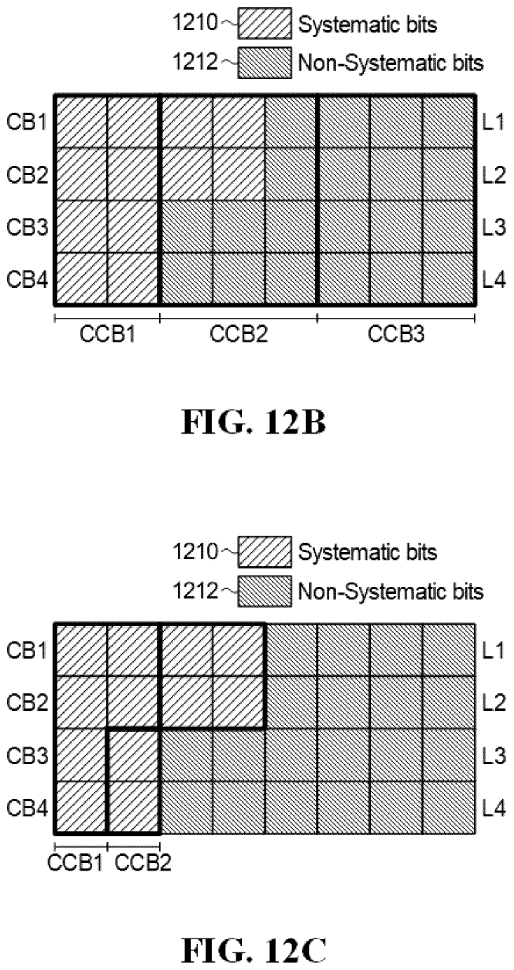

Detailed examples of cross-CB coding are provided below in the description of FIGS. 12A, 12B, and 12C.

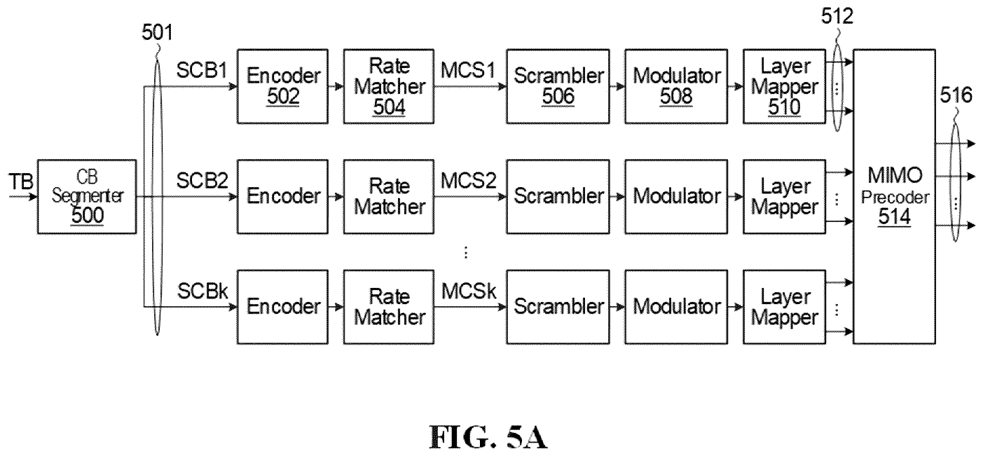

Referring now to FIG. 5A, a block diagram shows an example transmitter for implementing the new coding and MIMO structure to transmit a TB. A TB is a set of bits to be transmitted in a transmission. Although a TB is known to be a transport layer packet in some example communication systems, without loss of generality, the term “TB” may also be known to refer to other types of packets in different communication systems. Conversely, while the present disclosure refers to the set of bits to be transmitted as a TB in the interest of conciseness and convenience, the set of bits to be transmitted may also be known by other names, which would be apparent to a person skilled in the art.

In the example of FIG. 5A, a single TB is segmented into multiple SCBs 501, where each SCB has its own MCS and is mapped to multiple layers. The transmitter of FIG. 5A comprises a CB segmenter 500 at which a TB is segmented into multiple SCBs 501 each containing at least one CB. Before segmentation, the segmenter 500 optionally appends the TB with a cyclic redundancy check (CRC). In the example of FIG. 5A, each SCB has its own coding chain in the transmitter. The coding chain may also be known as an MCS chain, or more generally as a Tx chain, or simply, a chain. The coding chain depicted at the top of FIG. 5A will be described by way of example. At encoder 502, a CB-based CRC is optionally appended to the information bits of each CB. The CBs (optionally together with appended CRC) of a given SCB are each encoded using a same FEC code (e.g., turbo code, LDPC code, etc.) to produce a set of coded bits. Based on a selected MCS level for that SCB, at rate matcher 504, rate matching is performed for all CBs of the SCB. Rate matching involves selecting the coded bits based on code rate as well as redundancy version (RV), where the RV is typically identified based on predefined or configured RV index. If the SCB comprises more than one CB, the coded bits of each CB of the SCB are then concatenated to form the coded bits of the SCB. The coded bits of each SCB are then scrambled in scrambler 506 and modulated in modulator 508 to generate symbols according to a selected MCS for that SCB. The MCS information for the selected MCS may include the modulation level as well as code rate used for the encoding. In layer mapper 510, the modulated symbols are then mapped to the MIMO layers, and time and frequency resources, according to an SCB to layer mapping rule. Because a layer may be considered a form of resource, in some ways similar to time and frequency resources, the layer mapper may also be known as a resource mapper for mapping an SCB to resources according to a resource mapping rule, where the resources include layers. The information regarding which MIMO layers or how many MIMO layers to which each SCB is mapped can be signaled by the base station. A MIMO precoder 514 then processes the MIMO layer-mapped modulated symbols 512, from all of the layer mappers 510 to produce an overall MIMO output signal 516 to be transmitted on multiple antennas.

Each SCB may have its own MCS selection, so that the MCSs of SCBs can be different from each other. In addition, the total size of each SCB may be determined based on the resources of the corresponding mapped MIMO layer(s). Since channel quality and other properties of these mapped MIMO layer(s) may differ for each SCB, it could be advantageous for the SCB sizes to be different. After determining the SCB size, the CB size and the number of CBs in each SCB can be determined in a manner similar to conventionally determining a number of CBs and CB size for a TB. For example, the maximum CB size determined from the specific FEC scheme (e.g. the LDPC code) is denoted as Kmax, and the size of the SCB (number of information bits for the SCB) is denoted as S. Note that in some scenarios, the maximum CB size may not be determined by the FEC scheme itself; rather, it may be determined by some other factor such as a delay requirement. For example, in URLLC applications with a delay constraint, the actual block size or maximum block size may be a relatively smaller value to allow for fast decoding of the code block. In some scenarios, such a code block size or maximum code block size may be indicated by the base station in DCI or RRC signaling. If Kmax>=S, then the number of CBs C in the SCB is 1, and the CB size is the same as the SCB size, i.e., K=S. If Kmax<S, the number of CBs C can be determined as C=ceil (S/Kmax), where ceil is the ceiling function, which means C is the smallest integer that is larger than S/Kmax. The actual CB size K can then be determined as the smallest CB size, from the pool of all possible CB sizes, that is larger than or equal to S/C. The pool of possible CB sizes is determined based on the specific FEC design, which is similar to how possible CB sizes for LDPC code or polar code are defined in the NR standard.

FIG. 5B is a flowchart of a method provided by an embodiment of the application. The method begins in block 550 with transmitting a transmission of at least one transport block (TB). The TB comprises a plurality of sets of code blocks (SCBs), each SCB containing one or more code blocks (CBs), wherein each SCB is encoded and modulated to produce a corresponding set of modulated symbols. The transmission is generated from a plurality of MIMO layers. For each MIMO layer of the plurality of MIMO layers or for each group of MIMO layers of the plurality of MIMO layers, a respective one of said corresponding sets of modulated symbols is mapped to the MIMO layer or the group of MIMO layers. The method continues at 552 with receiving hybrid automatic repeat request (HARQ) feedback on a per TB basis.

FIG. 5C is a flowchart of a method provided by an embodiment of the application. The method begins at block 570 with receiving a transmission of at least one transport block (TB), the TB comprising a plurality of sets of code blocks (SCBs), each SCB containing one or more code blocks (CBs). Each SCB is encoded and modulated to produce a corresponding set of modulated symbols, the transmission generated from a plurality of MIMO layers. For each MIMO layer of the plurality of MIMO layers or for each group of MIMO layers of the plurality of MIMO layers, a respective one of said corresponding sets of modulated symbols is mapped to the MIMO layer or the group of MIMO layers. The method continues at 572 with transmitting hybrid automatic repeat request (HARQ) feedback on a per TB basis.

The description contains many example details for implementing the methods of FIGS. 5B and 5C. For example, the description contains examples of how SCBs are obtained from input bits, how coding can be applied, including possibly a cross-block coding scheme, how modulated symbols can be mapped to MIMO layers, how the MIMO layers thus mapped can be used in a transmission, specifics of HARQ feedback, and MCS adaptation.

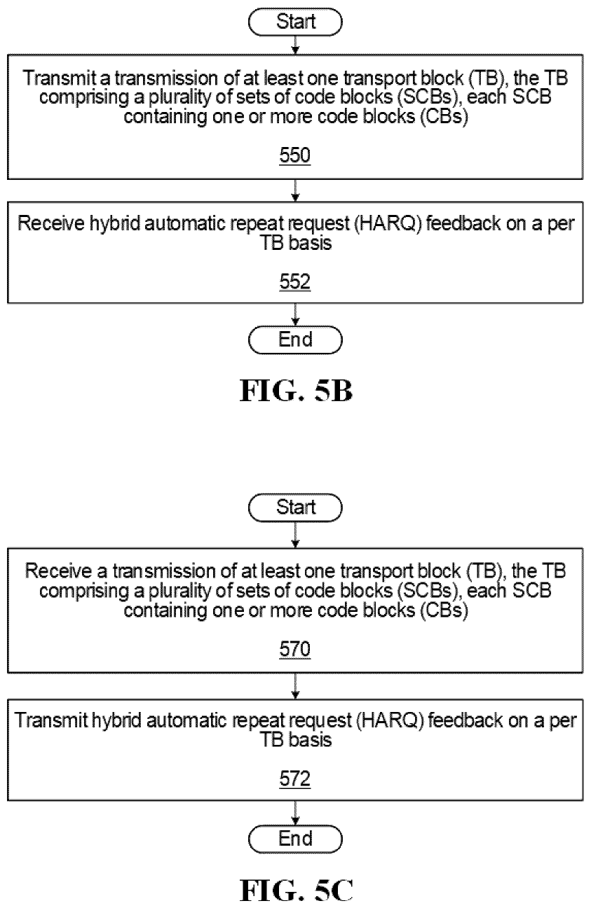

In the example of FIG. 5A, a single TB is segmented into multiple SCBs, where each SCB has its own MCS and is mapped to multiple layers. This example illustrates how multiple SCBs in a single TB can be mapped to MIMO layers. In general, however, multiple TBs may be available for one MIMO transmission, where each TB may contain multiple SCBs and be mapped in a similar way as shown in FIG. 5A. Further examples of SCB-level mapping and optimization are shown in FIGS. 6, 7 and 8.

In FIG. 6, each SCB of a TB is mapped to a single MIMO layer, and a respective MCS is applied. This example may be useful in a scenario where different MIMO layers have quite significant channel quality differences; thus, it is beneficial to have different respective MCS selected corresponding to each layer, which increases overall spectral efficiency. In contrast, the example of FIG. 5A illustrates MIMO layers grouped together according to MCS; this example is suitable for a case where the multiple MIMO layers that are grouped together have similar channel quality, and consequently it is not necessary to have different MCS selected for each individual MIMO layer in the group. Grouping multiple MIMO layers together in the example of FIG. 5 can reduce the overhead involved in selecting different MCSs. In addition, grouping multiple MIMO layers together can potentially increase the code length of the FEC if the amount of resources in each MIMO layer is small, which can potentially increase the performance of the FEC.

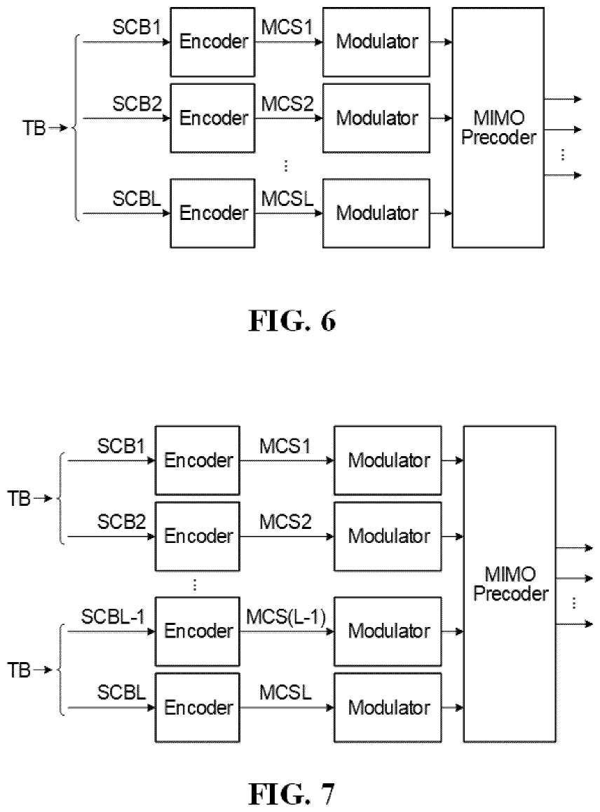

In FIG. 7, the structure of FIG. 6 is repeated for each of two TBs. There are multiple TBs corresponding to multiple HARQ processes, each TB corresponding to multiple SCBs, and each SCB is mapped to a single layer with its own MCS. Including multiple TBs for each MIMO transmission, provides the flexibility of having a separate HARQ feedback and/or separate HARQ process for each TB. Having a separate HARQ feedback may allow the transmitter to transmit new data in the TB that is decoded correctly and for which an ACK has been received from the HARQ feedback, while retransmitting another TB that is not decoded correctly and for which a NACK has been received from the HARQ feedback. In another example, not shown, there are multiple TBs, where each TB corresponds to multiple SCBs and each SCB (with its own MCS) is mapped to multiple layers.

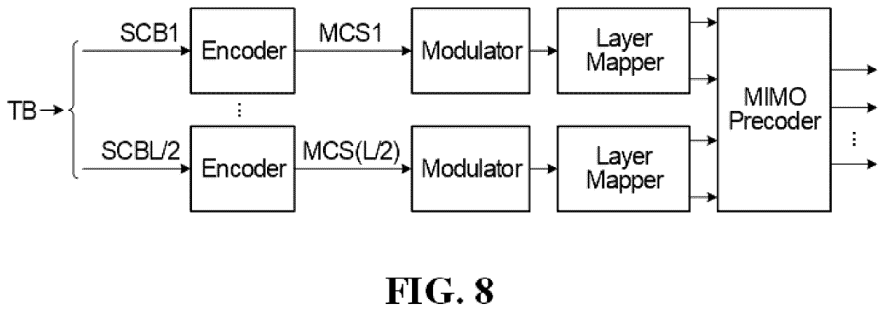

In FIG. 8, there is only 1 TB for the transmission, the layer mapping for each SCB maps to a respective pair of MIMO layers.

In general, the number of TBs used for a MIMO transmission, the number of MIMO layers to which each SCB is mapped, and other parameters in SCB-level mapping optimization may be determined based on at least the technical reasons described above. The decision may be set by a predefined rule or may be made by the transmitter (e.g., a base station) based on information it has collected, such as channel quality feedback. The transmitter can then signal the decision to the receiver (e.g., a UE) using signaling schemes described in further detail below.

### Example Method of SCB Size and MCS Determination for DL Transmission

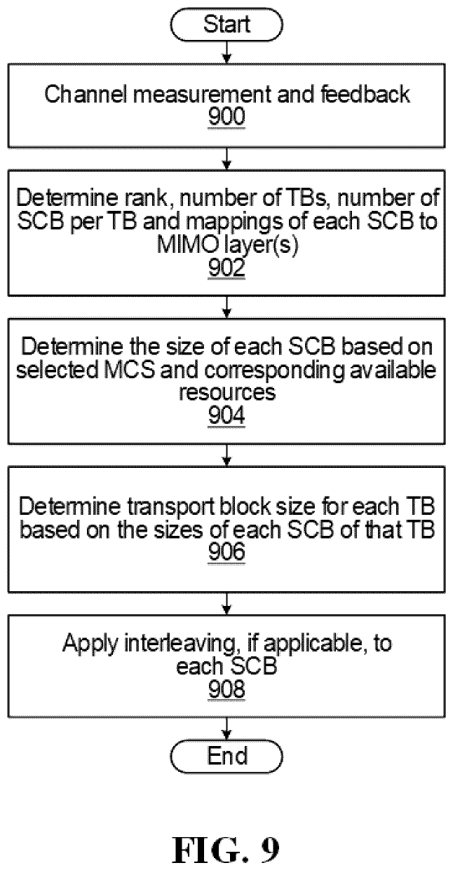

Referring to FIG. 9, a flowchart of a method is shown. The method shown is an example for determining SCB size and MCS for downlink transmission. The example also illustrates some related channel quality feedback procedures. The method begins at block 900 with channel measurement and feedback. Performing channel measurement and feedback may be similar to, or based on, known procedures such as those currently implemented in NR. In a frequency division duplex (FDD) scenario for NR, a UE performs channel measurement from a channel state information-reference signal (CSI-RS) and feeds back information such as one or more of rank (i.e., transmission rank, or the number of transmission layers L), precoding matrix indicator (PMI), and channel quality information (CQI) for each layer. The CQI information can, for example, be in the form of signal to interference and noise ratio (SINR) or maximum supported MCS. On the other hand, in a time division duplex (TDD) scenario, a BS performs CSI measurement from a sounding reference signal (SRS) transmitted by the UE. Specific channel measurement and feedback procedures known in NR have been described as examples only, and without loss of generality; suitable channel measurement and feedback procedures would be apparent to the person skilled in the art. In block 902, based on the channel quality feedback from the UE, or its own channel measurement, the BS determines rank, number of TBs, number of CBs or SCBs per TB, and mappings of each CB/SCB to MIMO layers for the transmission. Each TB has its own HARQ process and independent HARQ feedback while an MCS for each SCB is selected separately based on the MIMO layer(s) mappings. In block 904, the size of each SCB is determined based on the selected MCS and corresponding available resources to which it maps (including the time-frequency resource to which it is scheduled, the corresponding MIMO layers, etc.). The amount of available time, frequency, and spatial (i.e., layer) resources determines the number of resource elements that can be used to transmit the SCB, which together with the selected MCS, determines the size of the SCB in terms of a number of information bits. If the size obtained from this method is larger than the maximum CB size the FEC supports, or larger than a predefined or signaled maximum CB size, then the SCB(s) may be further segmented as discussed earlier. In block 906, transport block size for each TB is determined based on the sum of all sizes of SCB of that TB. In block 908, interleaving, if applicable, is applied to each SCB.

In some embodiments, one or multiple SCBs can be defined to correspond to a code-block group (CBG). Each SCB has its own MCS and is mapped to separate MIMO layers on a per SCB basis as described before. A TB may contain multiple CBGs. Each CBG may have its own ACK/NCK feedback. However, in this scenario, a TB has its own HARQ process ID while each CBG does not have its own HARQ process ID. In addition, if a CBG contains multiple SCBs, each SCB can still have its own MCS; thus, the CBG can still contain CBs that use different MCSs.

### Example Signaling Mechanism

To support the provided system and method, a signaling mechanism is provided that may be used by a BS in some embodiments to inform the UE about how CBs are grouped and mapped to layer(s). The signaling can be communicated using downlink control information (DCI) or using a combination of radio resource control (RRC) and DCI. All the signaling described below may be signaling in RRC and/or DCI. Various divisions of what signaling content is sent using RRC as opposed to DCI can be used. For example, one division involves using RRC to define more static parameters (e.g., ranges of parameters), and using DCI to dynamically signal an actual value for a given parameter for each transmission. For example, RRC can be used to define a maximum number of TBs, and DCI can be used to indicate an actual number of TBs. Similarly, RRC may indicate a maximum number of SCBs supported for each TB, and DCI can be used to indicate actual number for a given data transmission.

In some embodiments, the signaling content to support the provided mechanism can include or indicate one or more of the following fields:
Number of TBs and corresponding HARQ process ID(s) per TB. In some embodiments, the multiple TBs in the same MIMO transmission may share the same HARQ process ID, but the index of the TB (e.g. in the case of 2 TBs, the first TB and the second TB) can be used to further identify the actual HARQ process to which the TB corresponds.
Number of MIMO layers (MIMO group) each SCB maps to. This field can be a single number where each SCB maps to a same number of layers, or a respective number for each SCB where each SCB can map to a different number of layers (or number of SCB per TB). In a specific example, based on a total number of TBs to be included in a transmission and a total number of MIMO layers, the number of MIMO layers to which each TB maps can be determined. With knowledge of the number of SCB per TB, the number of layers to which each SCB maps can also be determined.
Number of SCBs per TB. As explained above, in some scenarios, this parameter can be in addition to or to replace the parameter of the number of MIMO layers that maps to each SCB. This is because the knowledge of the number of SCBs per TB can be used to determine the number of MIMO layers that maps to each SCB and vice versa.
MCS list specifying an MCS for each SCB. In one example, this signaling content can be a bit map. There may be a defined maximum number of MCS that can be chosen between for each SCB; defining a maximum may help to reduce overhead. For example, there may be a reduced set of entries of potential MCS for each SCB, e.g. from a new MCS table that contains fewer entries. For example, an original or initial MCS table for MCS adaptation may have 32 entries, which correspond to 32 potential MCS choices. Signaling one entry from this table requires 5 bits to indicate the MCS selection. In a new, modified, or reduced MCS table, the number of MCS choices may be reduced to 16. Signaling one entry from this table only requires 4 bits to indicate each MCS selection. The choice of MCS table (e.g., original or new, 32 entries or 16 entries, etc.) may be implicitly or explicitly associated with some other parameter, or it may be explicitly indicated in control signaling, either separately from or along with the MCS selection. In some other embodiments, there may be limitations on the size of the set of MCS choices, which helps to reduce the number of bits needed to indicate a selected MCS. For example, different SCBs may be constrained to have the same modulation but can have different code rates; in this scenario, the set of MCS choices only include the different code rates.
Maximum CB size (if different than default, e.g. short CB size for URLLC).
Method of mapping SCBs to corresponding layers (e.g., a mapping order of frequency first-time second or time first-frequency second).

The list above is only an example. Other signaling content can be used.

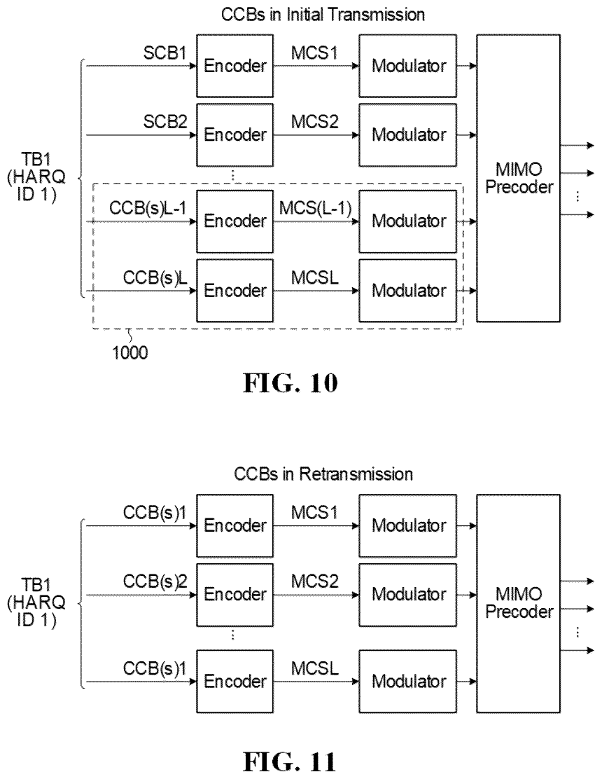

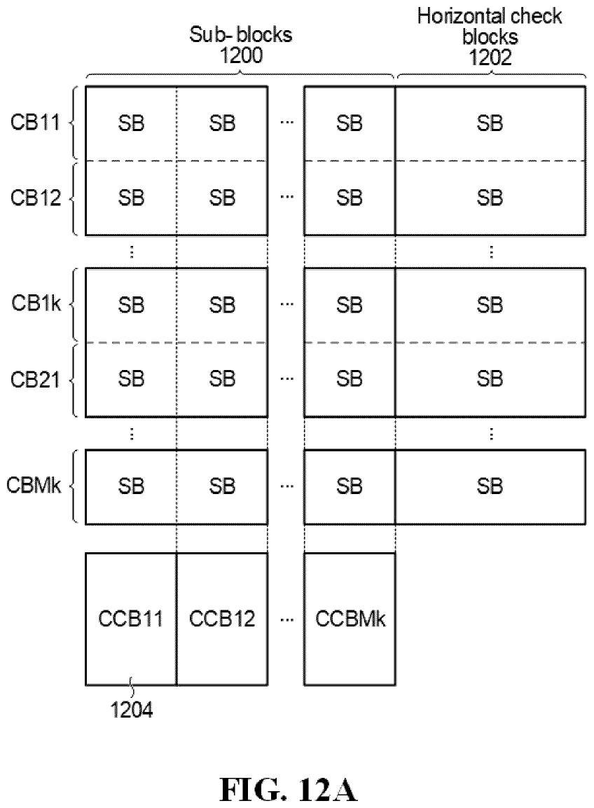

FIG. 10 a block diagram of a variant of the embodiment of FIG. 6. The embodiment of FIG. 10 comprises a cross-CB coding scheme with the previously-described coding and MIMO layer mapping scheme. Instead of all the MIMO layers being mapped to data SCBs as in the embodiment of FIG. 6, some of the MIMO layers are to CCBs (or sets of CCBs). In the example of FIG. 10, CCB encoding, modulation, and mapping to the last two MIMO layers is shown generally at 1000. In the example of FIG. 10, the CCBs are included as part of the initial transmission. Alternatively, CCBs may be used in a retransmission. An example of CCBs used in a retransmission is shown in FIG. 11, which is a block diagram of a variant of the preceding embodiments, for a retransmission only containing CCBs. In this case, only CCBs are mapped to MIMO layers. The SCBs of the TB were transmitted in a previous transmission, for example using the structure of FIG. 6. As before, each individual CCB may be mapped to an individual MIMO layer or set of MIMO layers, or each set of CCBs may be mapped to an individual MIMO layer or sets of MIMO layers.

A cross-CB coding scheme usually does not need per-layer feedback. This is because a cross-CB coding scheme allows joint decoding of all CBs that are used for cross-CB coding These CBs have been mapped to different MIMO layers, thus the successes of decoding different CBs that are used to generate each CCB are highly correlated to each other. Consequently, the transmission of a single feedback for all CBs that are used for cross-CB coding to generate CCBs is usually sufficient. Having different feedback for different CBs that are used for cross-CB coding may unnecessarily increase feedback overhead and waste feedback resources. Cross-CB coding is used across multiple CBs which have independent MCS adaptation but form part of the same TB; therefore, the multiple CBs are associated with the same HARQ process and do not contribute to an increase in HARQ-related overhead. No HARQ feedback is needed for each individual SCB because the SCBs used for cross-CB coding are jointly decoded and the decoding results are highly correlated (i.e., if one SCB is decoded successfully, the other SCBs used for cross-CB coding are likely to be decoded successfully as well, and vice versa). Joint decoding of different SCBs mapped to different MIMO layers in a cross-CB coding scheme also maximizes diversity gain across multiple layers.

FIGS. 12A-12C show more details of the cross-CB coding scheme and illustrate example embodiments for generating cross-block check blocks.

FIG. 12A illustrates an example TB. This example shows how a set of cross-block check blocks CCB11 to CCBMk may be generated by sampling bits from across the CBs of a TB. In FIG. 12A, each of CB11, CB12, . . . . CBMk represents a code block of the TB, where the TB contains M SCBs and each SCB contains k CBs, and CBmj (1<=m<=M, 1<=j<=k) represents a j-th CB in an m-th SCB. In this example, each SCB has the same number of code blocks, namely k, but this need not be the case in general. More generally, each SCB has at least one code block. Also shown are horizontal check blocks 1202 for each CB. The horizontal check blocks 1202 are referred to as such as for convenience because they are based on information bits of a CB in a single row, according to the example orientation of the CBs in FIG. 12A. However, the example orientation is not intended to be limiting, and the cross-CB coding scheme can be represented in alternative fashions without changing the technical result of the cross-CB coding scheme. For example, if CBs are represented as columns, the check block for each CB would be oriented vertically. It would be apparent to the person skilled in the art that the horizontal check blocks 1202 may generally be known by other names such as CB check blocks, code block check blocks, or simply as check blocks. Each CB may be divided into multiple sub-blocks 1200, where each sub-block contains one or more information bits of the CB. Cross-block check blocks (CCB) 1204 are determined based on bits from across all the CBs. In the illustrated example, CCB11, for example, is based on bits from the first sub-block of each of the CBs. In this example, the CCBs are not generated from the bits of the set of horizontal check blocks 1202, however in other examples there may be one or more cross-block check blocks generated from bits selected across the horizontal check blocks 1202. In some embodiments, each cross-block check block may be generated from a column of sub-blocks (i.e., generated from all of the bits of each sub-block) spanning across all the CBs.

The set of CCBs 1204 is transmitted over one or more MIMO layers. For example, the CCB11 to CCBMk may be mapped, by a layer mapping operation, to one or more MIMO layers. The layers are then processed by the MIMO precoder and may be transmitted in a retransmission. The retransmission may have any RV index number (e.g., the RV index may be associated with and indicative of an interleaver used to generate the cross-block check blocks), however the RVo index may be reserved for the initial transmission.

In some embodiments, one or more of the generated CCBs may be transmitted over a MIMO layer in the initial transmission. This may be the case if one or more MIMO layers remain available after the SCBs have been mapped to the MIMO layers.

Due to different MCS used for different SCBs that correspond to different MIMO layers, SCBs may have different numbers of information bits. FIGS. 12B and 12C show two different ways to apply a cross-CB coding scheme for different SCBs with different CB size, for a scenario in which each SCB is a single CB.

In FIGS. 12B and 12C, the parts with hatching 1210 represent systematic bits or information bits and parts with hatching 1212 represent non-systematic code bits. In some FEC coding schemes, the output bits after encoding includes the information bits and parity bits. Parity bits may also be known as check bits. The portion of bits that corresponds to the information bits in the encoder output may also be known as systematic bits. The parity bits (or non-information bits portion) of the encoder output may also be known as non-systematic bits. In each of FIGS. 12B and 12C, each row contains a respective CB containing systematic bits and non-systematic bits. All the CBs are part of the same TB. In the example, there are 4 CBs, and each CB contains 8 bits, but more generally, the same approach can be applied to an arbitrary number of CBs of arbitrary size. In the examples of FIGS. 12B and 12C, the CBs do not have equal numbers of systematic bits. This is because each CB may have different code rates chosen independently from each other. In the example of FIG. 12B, the first two CBs, CB1, CB2 have 4 systematic bits and the next two CBs, CB3,CB4 have two systematic bits.

With the first example shown in FIG. 12B, CCBs are generated based on both information bits and parity bits of the horizontal CBs. A first CCB1 is generated based on the first two bits of each CB. A next CCB2 is generated based on the next three bits of each CB (including systematic and non-systematic bits) and the last CCB3 is generated based on the last three bits of each CB (including only non-systematic bits). In the case where the total number of encoded bits (which includes both information bits and parity bits) is the same for all CBs, the same number of bits can be taken from each CB to generate a CCB. Since each CCB may also have different MCS based on its own MIMO layer mapping, the total number of bits across different CBs that a CCB is generated from is determined based on its own MCS; thus, the total number of bits for which each CCB is generated from can be different for different CCBs, as shown in the example of FIG. 12B, where CCB1 is generated based on a total of 8 bits from all the 4 CBs, while CCB2 and CCB3 are generated based on 12 bits from all the 4 CBs.

In the second example shown in FIG. 12C, CCBs are generated based only on information bits. Due to different numbers of information bits in each layer, CCBs may be generated from different numbers of information bits from each layer. For example, each CCB may be based on a number of bits proportional to the number of information bits in each CB. Again, the total number of bits across different CBs from which each CCB is generated is determined based on its own MCS adaptation. In the example of FIG. 12C, the first CCB1 is generated based on two information bits from each of CB1,CB2, and one information bit from each of CB3,CB4. Similarly, the second CCB2 is based on two information bits from each of CB1, CB2, and one information bit from each of CB3,CB4. In the example of FIG. 12C, the MCS and available resources for transmitting CCB1 and CCB2 may be the same, thus the total number of bits used to generate both CCBs are the same 6 bits.

An example of a procedure for partitioning CBs to produce CCBs can be summarized as follows. Without loss of generality, the procedure assumes only information bits from horizontal CBs are used to generate CCBs as in FIG. 12B. However, the procedure can be easily adapted to the case in FIG. 12C, where both information bits and parity bits of horizontal CBs are used to generate CCBs, by replacing the number of information bits of each CB with the total number encoded bits of each CB. First, the MCS of each CB is determined based on a channel quality of a corresponding MIMO layer(s) to which the CB (or the SCB it belongs to) maps, and the code block size of each CB is determined based on the available time and frequency resources on the corresponding aforementioned MIMO layer(s). Similarly, the MCS of each CCB is determined based on a channel quality of a corresponding MIMO layer(s) to which the CCB maps, and the total number of information bits used to generate the CCB is determined based on the available time and frequency resources on the corresponding aforementioned MIMO layers. Once the total the number of bits used to generate each CCB is determined, the number of information bits taken from each CB is proportional to the size of each CB. For example, assume that there are a total of M CBs, where an r-th CB contains Kr information bits. The total number of information bits for CCB1 is N bits. Then the number of information bits for the r-th CB used to generate CCB1 is determined to be Tr, such that T1+T2+ . . . . TM=N and T1/K1=T2/K2= . . . . TM/KM. Note that if the number of bits determined from the above equations are not integers, the number can be rounded such that Tr/Kr are nearly equal for r=1, 2, . . . , M CBs. As shown in the example in FIG. 12C, the number of information bits in CB1 and CB2 are twice the number of information bits in CB3 and CB4. Thus the number of information bits selected in CB1 and CB2 to generate CCB1 is also twice the number of information bits selected in CB3 and CB4. The same applies to CCB2. In the case where CB1 to CB4 are used for initial transmission and CCB1 and CCB2 are used for retransmission, if the amount of resources and channel quality feedback for initial and retransmission are almost the same, then the total number of information bits to generate the CBs and CCBs are also approximately the same; therefore, the total number of bits used to generate CCB1 and CCB2 are also the same as total number of information bits in CB1 to CB4 in FIG. 12C. Once the number of information bits used to generate each CCB is determined, the number of encoded bits for each CCB is determined based on the MCS and the number of information bits for each CCB.

In some scenarios, multiple SCBs of a TB subject to cross-CB coding can have the same modulation but different coding rate. This MCS adaptation configuration may, for example, optimize decoding performance.

Signaling content for embodiments that use cross-CB coding may include the fields that are described previously for the general scenario without cross-CB coding. The signaling content for embodiments that use cross-CB coding may further include one or more of the following fields, and/or additional fields, or different fields altogether:
Number of TBs.
For each TB, a corresponding HARQ process ID. In some embodiments, the multiple TBs in the same MIMO transmission may share the same HARQ process ID, but the index of the TB (e.g. in the case of 2 TBs, the first TB and the second TB) can be used to further identify the actual HARQ process to which each TB corresponds.
Number of layers (MIMO group) to which each SCB or CCB(s) maps, and/or number of SCBs and CCB(s) per TB.
MCS list indicating MCS each SCB and CCB(s). In one example, this signaling content can be a bit map. There may be a defined maximum number of MCS that can be chosen between for each SCB; defining a maximum may help to reduce overhead. For example, there may be a reduced set of entries of potential MCS for each SCB, e.g. from a new MCS table with fewer entries. In some other embodiments, there may be limitations on the set of MCS choices, which helps to reduce the number of bits needed to indicate a selected MCS. For example, different SCBs may be constrained to have the same modulation but can have different code rates; in this scenario, the set of MCS choices only include the different code rates.
RV version (e.g., “o” for initial transmission, another index value for retransmission).
Interleaver for cross-CB coding. An interleaver indication will define (either directly or indirectly) how bits from CBs of a TB are selected and input to the cross-CB encoder to produce CCBs. In some embodiments, each RV may correspond to a respective interleaver for cross-CB coding. For example, RV=0 is for an initial transmission, and other RVs correspond to different interleavers.
The number of CCBs included in the transmission, if both SCB and CCB are to be included in an initial transmission.
Maximum CB size (if different than default, e.g. short CB size for URLLC).
Method of mapping SCBs to corresponding layers (e.g., a mapping order of frequency first-time second or time first-frequency second).

Numerous modifications and variations of the present disclosure are possible in light of the above teachings. It is therefore to be understood that within the scope of the appended claims, the disclosure may be practiced otherwise than as specifically described herein.

1. A method comprising:
transmitting a transmission of at least one transport block (TB), a TB of the at least one TB comprising a plurality of sets of code blocks (SCBs), each SCB of the plurality of SCBs containing one or more code blocks (CBs), wherein each SCB of the plurality of SCBs is encoded and modulated to produce a corresponding set of modulated symbols, the transmission generated from a plurality of multiple-input multiple-output (MIMO) layers, wherein for each MIMO layer of the plurality of MIMO layers or for each group of MIMO layers of the plurality of MIMO layers, a respective set of corresponding sets of modulated symbols is mapped to each MIMO layer or each group of MIMO layers; and
receiving a hybrid automatic repeat request (HARQ) feedback on a per TB basis.

2. The method of claim 1, wherein the receiving the HARQ feedback on the per TB basis comprises:
receiving a HARQ acknowledgment (ACK) or a HARQ negative acknowledgment (NACK) for each TB without receiving HARQ feedbacks for all of the plurality of SCBs.

3. The method of claim 1, wherein:
a size of each SCB is based on resources available on a respective MIMO layer or a respective group of MIMO layers to which each SCB is mapped.

4. The method of claim 1, wherein the transmission of the at least one TB further comprises a transmission of at least one cross-CB check block (CCB), each CCB of the at least one CCB being a check block based on a respective set of bits that includes at least one bit from each CB of the plurality of SCBs of the TB.

5. The method of claim 1, further comprising:
with respect to at least one of the at least one TB, transmitting a retransmission of the TB, the retransmission comprising at least one cross-block check block (CCB), each CCB of the at least one CCB being a check block based on a respective set of bits that includes at least one bit from each CB of the plurality of SCBs of the TB.

6. An apparatus comprising:
at least one processor; and
a non-transitory computer readable storage medium, coupled to the at least one processor, storing instructions for execution by the at least one processor to cause the apparatus to perform operations including:
transmitting a transmission of at least one transport block (TB), a TB of the at least one TB comprising a plurality of sets of code blocks (SCBs), each SCB of the plurality of SCBs containing one or more code blocks (CBs), wherein each SCB of the plurality of SCBs is encoded and modulated to produce a corresponding set of modulated symbols, the transmission generated from a plurality of multiple-input multiple-output (MIMO) layers, wherein for each MIMO layer of the plurality of MIMO layers or for each group of MIMO layers of the plurality of MIMO layers, a respective set of corresponding sets of modulated symbols is mapped to each MIMO layer or each group of MIMO layers; and
receiving a hybrid automatic repeat request (HARQ) feedback on a per TB basis.

7. The apparatus of claim 6, wherein the receiving the HARQ feedback on the per TB basis comprises:
receiving a HARQ acknowledgment (ACK) or a HARQ negative acknowledgment (NACK) for each TB without receiving HARQ feedbacks for all of the plurality of SCBs.

8. The apparatus of claim 6, wherein:
a size of each SCB is based on resources available on a respective MIMO layer or a respective group of MIMO layers to which each SCB is mapped.

9. The apparatus of claim 6, wherein the transmission of the at least one TB further comprises a transmission of at least one cross-CB check block (CCB), each CCB of the at least one CCB being a check block based on a respective set of bits that includes at least one bit from each CB of the plurality of SCBs of the TB.

10. The apparatus of claim 6, the operations further comprising:
with respect to at least one of the at least one TB, transmit a retransmission of the TB, the retransmission comprising at least one cross-block check block (CCB), each CCB of the at least one CCB being a check block based on a respective set of bits that includes at least one bit from each CB of the plurality of SCBs of the TB.

11. A method comprising:
receiving a transmission of at least one transport block (TB), a TB of the at least one TB comprising a plurality of sets of code blocks (SCBs), each SCB of the plurality of SCBs containing one or more code blocks (CBs), wherein each SCB of the plurality of SCBs is encoded and modulated to produce a corresponding set of modulated symbols, the transmission generated from a plurality of multiple-input multiple-output (MIMO) layers, wherein for each MIMO layer of the plurality of MIMO layers or for each group of MIMO layers of the plurality of MIMO layers, a respective set of corresponding sets of modulated symbols is mapped to each MIMO layer or each group of MIMO layers; and
transmitting a hybrid automatic repeat request (HARQ) feedback on a per TB basis.

12. The method of claim 11, wherein the transmitting the HARQ feedback on the per TB basis comprises:
transmitting a HARQ acknowledgment (ACK) or a HARQ negative acknowledgment (NACK) for each TB without transmitting HARQ feedbacks for all of the plurality of SCBs.

13. The method of claim 11, wherein:
a size of each SCB is based on resources available on a respective MIMO layer or a respective group of MIMO layers to which each SCB is mapped.

14. The method of claim 11, wherein the transmission of the at least one TB further comprises a transmission of at least one cross-CB check block (CCB), each CCB of the at least one CCB being a check block based on a respective set of bits that includes at least one bit from each CB of the plurality of SCBs of the TB.

15. The method of claim 11, further comprising:
with respect to at least one of the at least one TB, receiving a retransmission of the TB, the retransmission comprising at least one cross-block check block (CCB), each CCB of the at least one CCB being a check block based on a respective set of bits that includes at least one bit from each CB of the plurality of SCBs of the TB.

16. An apparatus comprising:
at least one processor; and
a non-transitory computer readable storage medium, coupled to the at least one processor, storing instructions for execution by the at least one processor to cause the apparatus to perform operations including:
receiving a transmission of at least one transport block (TB), a TB of the at least one TB comprising a plurality of sets of code blocks (SCBs), each SCB of the plurality of SCBs containing one or more code blocks (CBs), wherein each SCB of the plurality of SCBs is encoded and modulated to produce a corresponding set of modulated symbols, the transmission generated from a plurality of multiple-input multiple-output (MIMO) layers, wherein for each MIMO layer of the plurality of MIMO layers or for each group of MIMO layers of the plurality of MIMO layers, a respective set of corresponding sets of modulated symbols is mapped to each MIMO layer or each group of MIMO layers; and
transmitting a hybrid automatic repeat request (HARQ) feedback on a per TB basis.

17. The apparatus of claim 16, wherein the transmitting the HARQ feedback on the per TB basis comprises:
transmitting a HARQ acknowledgment (ACK) or a HARQ negative acknowledgment (NACK) for each TB without transmitting HARQ feedbacks for all of the plurality of SCBs.

18. The apparatus of claim 16, wherein:
a size of each SCB is based on resources available on a respective MIMO layer or a respective group of MIMO layers to which each SCB is mapped.

19. The apparatus of claim 16, wherein the transmission of the at least one TB further comprises a transmission of at least one cross-CB check block (CCB), each CCB of the at least one CCB being a check block based on a respective set of bits that includes at least one bit from each CB of the plurality of SCBs of the TB.

20. The apparatus of claim 16, the operations further comprising:
with respect to at least one of the at least one TB, receive a retransmission of the TB, the retransmission comprising at least one cross-block check block (CCB), each CCB of the at least one CCB being a check block based on a respective set of bits that includes at least one bit from each CB of the plurality of SCBs of the TB.
